(19) United States
(12) Patent Application Publication
(10) Pub. No.: US 2026/0097300 A1
(43) Pub. Date: Apr. 9, 2026

(54) VEHICLE

(71) Applicant: Honda Motor Co., Ltd., Tokyo (JP)

(72) Inventors: Saul Mijael Ibaven Bueno, Columbus, OH (US); Alain Ortega Zavaleta, Columbus, OH (US)

(21) Appl. No.: 18/910,943

(22) Filed: Oct. 9, 2024

(51) Int. Cl. A63F 13/23; A63F 13/533; A63F 13/54; A63F 13/803; G07C 5/08

(52) U.S. Cl. CPC A63F 13/23; A63F 13/533; A63F 13/54; A63F 13/803; A63F 2300/8082; G07C 5/0808

(57) ABSTRACT

A vehicle includes at least one input device adapted to be operated by a user to control at least one driving function of the vehicle, and an onboard diagnostic port adapted to be engaged with a dongle. The vehicle also includes a controller configured to detect the engagement of the dongle with the onboard diagnostic port, and activate a game mode of the vehicle upon detection of the engagement of the dongle with the port. The controller is further configured to disable an ignition of the vehicle in response to the activation of the game mode, and associate the at least one input device with at least one control function of a game to be played using a virtual reality headset. The control function of the game being played on the virtual reality headset is controlled in response to the actuation of the input device.

### BACKGROUND

The disclosed subject matter relates generally to a vehicle. More particularly, the disclosed subject matter relates to a vehicle having a game mode and a dongle adapted to be connected to the vehicle to enable the game mode to facilitate a control of a game being played on a virtual reality headset by at least one input device of the vehicle.

Charging times for electric vehicles are currently very high, demanding automakers to offer entertainment or distraction while the vehicles are charging. Currently, there are infotainment systems that offer games on the vehicle screens, however the games offered on the vehicle screens are limited and do not provide a good and entertaining experience to the users.

### SUMMARY

In accordance with one embodiment of the present disclosure, a vehicle is provided. The vehicle includes at least one input device adapted to be operated by a user to control at least one driving function of the vehicle, and an onboard diagnostic port adapted to be engaged with a dongle. The vehicle also includes a controller communicatively coupled to the onboard diagnostic port, the dongle and the at least one input device. The controller is configured to detect the engagement of the dongle with the onboard diagnostic port, and activate a game mode of the vehicle upon detection of the engagement of the dongle with the onboard diagnostic port. The controller is further configured to disable an ignition of the vehicle in response to the activation of the game mode, and associate the at least one input device with at least one control function of a game adapted to be played using a virtual reality headset. The at least one control function of the game being played on the virtual reality headset is controlled in response to the actuation of the at least one input device.

In accordance with another embodiment of the present disclosure, a vehicle system is provided. The vehicle system includes a dongle, and a vehicle. The vehicle includes at least one input device adapted to be operated by a user to control at least one driving function of the vehicle, and an onboard diagnostic port. The dongle is adapted to be removably coupled to the onboard diagnostic port and configured to facilitate a sharing of control instructions from the vehicle to a virtual reality headset to enable a user to control a game on the virtual reality headset. The vehicle also includes a controller communicatively coupled to the onboard diagnostic port, the dongle and the at least one input device. The controller is configured to detect an engagement of the dongle with the onboard diagnostic port, and activate a game mode of the vehicle upon detection of the engagement of the dongle with the onboard diagnostic port. The controller is also configured to disable an ignition of the vehicle in response to the activation of the game mode, and associate the at least one input device with at least one control function of a game adapted to be played using the virtual reality headset. The at least one control function of the game being played on the virtual reality headset is controlled in response to the actuation of the at least one input device.

In accordance with yet a further embodiment of the present disclosure a dongle is provided. The dongle is adapted to be connected to an onboard diagnostic port of a vehicle. The vehicle includes at least one input device to control at least one driving function of the vehicle. The dongle comprises a controller configured to facilitate an activation of a game mode of the vehicle, and connect the vehicle to a virtual reality headset to enable a user to play a game. The controller is also configured to receive at least one control instruction generated in response to an actuation of the at least one input device upon activation of the game mode of the vehicle, and share the at least one control instruction with the virtual reality headset to enable a user to control of at least one control function of the game being played on a virtual reality headset via the at least one input device.

### BRIEF DESCRIPTION OF THE DRAWINGS

Certain embodiments of the present disclosure will be better understood from the following description taken in conjunction with the accompanying drawings in which:

FIG. 1 is a schematic view of a vehicle system having a vehicle and a dongle adapted to interact with a virtual reality headset to enable a playing of a game to a user, in accordance with one embodiment of the present disclosure;

FIG. 2 illustrates a portion of an interior of the vehicle depicting an infotainment system and at least one input device of the vehicle, in accordance with one embodiment of the present disclosure;

FIG. 3 is a block diagram of the vehicle system of FIG. 1 and schematically depicting various components of the vehicle and the dongle, in accordance with one embodiment of the present disclosure;

FIG. 4 is a zoom view of the infotainment system of the vehicle displaying a message to prompt a user to activate a game mode of the vehicle, in accordance with one embodiment of the present disclosure;

FIG. 5 is a zoom view of the infotainment system of the vehicle displaying a message to prompt a user to select an external device for connection with the vehicle to enable the user to play a game, in accordance with one embodiment of the present disclosure;

FIG. 6 is a portion of an interior of the vehicle depicting a virtual screen of the virtual reality headset depicting a notification related to a vehicle parameter on a game screen, in accordance with one embodiment of the present disclosure; and

FIG. 7 is a portion of an interior of the vehicle depicting the virtual screen having a shape and size of a windshield of the vehicle with the notification related to a vehicle parameter displayed on a game screen, in accordance with one embodiment of the present disclosure.

### DETAILED DESCRIPTION OF EXEMPLARY EMBODIMENTS

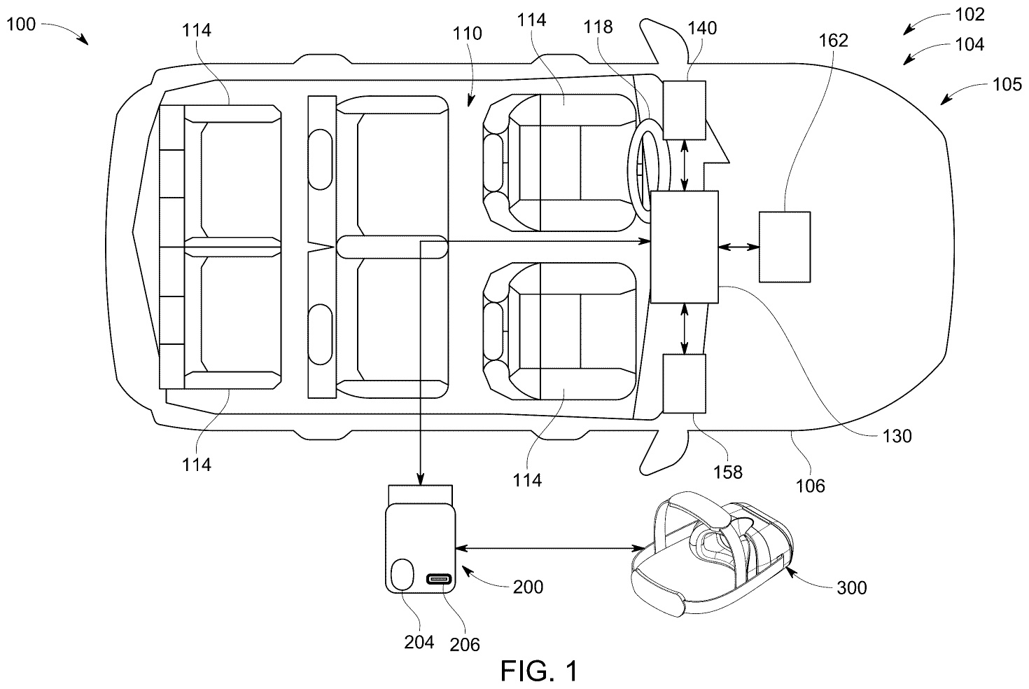

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-7, wherein like numbers indicate the same or corresponding elements throughout the views.

FIG. 1 illustrates a schematic view of a vehicle system, indicated generally at 100, and having a vehicle 102 and a dongle 200 adapted to be used with the vehicle 102 and configured to facilitate a communication and data exchange between a virtual reality (VR) headset 300 and the vehicle 102 to enable a user to play a game using at least one input device of the vehicle 102, in accordance with one embodiment of the present disclosure. The vehicle 102 is shown as a sedan 104. However, vehicle 102 in accordance with alternative embodiments can comprise any variety of vehicles, including trucks, vans, recreational vehicles, utility vehicles, agricultural equipment, or construction equipment, for example. In some embodiments, the vehicle 102 may be an electric vehicle 105 having at least one battery 162 to power the vehicle 102. Referring to FIGS. 1 to 3, the vehicle 102 includes a vehicle body 106 to which various components of the vehicle 102 are mounted, and a plurality of traction members, for example, wheels, movably supporting the vehicle body 106 on a ground surface. Also, the vehicle body 106 defines a passenger compartment 110 with a plurality of seats 114 arranged inside the passenger compartment 110 to facilitate seating of one or more passengers/users inside the vehicle 102.

Moreover, the vehicle 102 includes at least one input device 115, for example, a steering wheel 118 that facilitates a steering of the wheels of the vehicle 102, a gear selector 120 adapted to facilitate the user to select a desired gear of a transmission of the vehicle 102, a brake lever 122 to apply brakes to the wheels of the vehicle 102, an indicator selector 124 o facilitate the user to activate and deactivate turn indicator lights of the vehicle 102, a throttle lever/accelerator pedal 126 to accelerate the vehicle 102, etc.

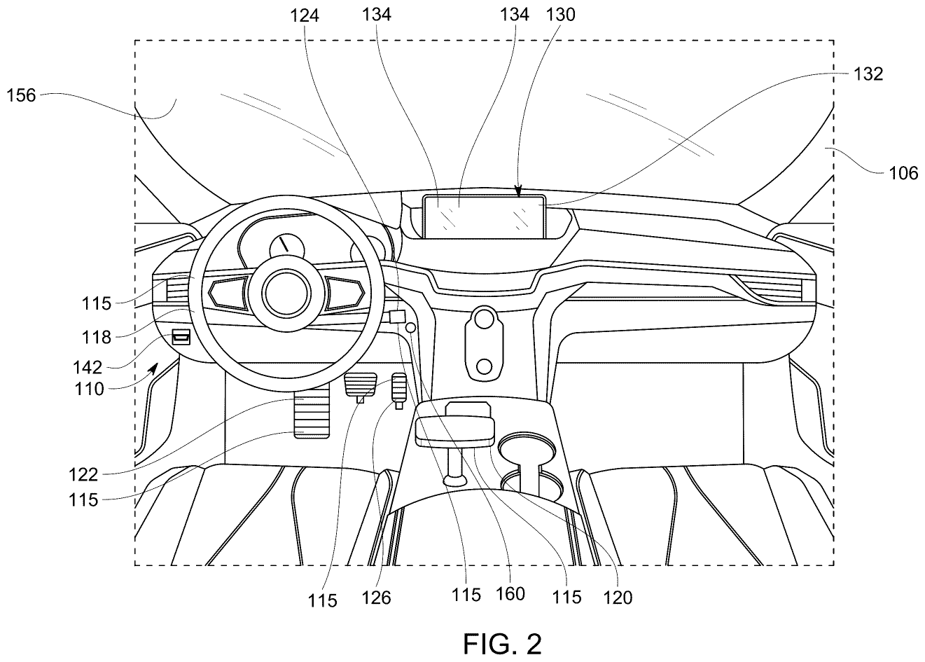

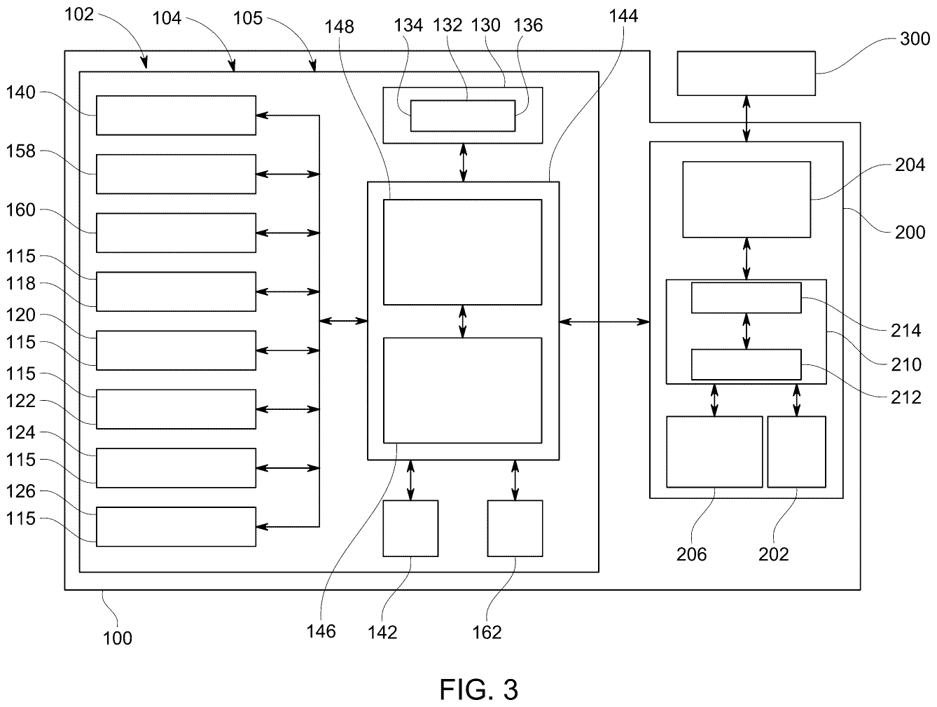

Further, the vehicle 102 includes an infotainment system 130 to provide a combination of entertainment and information to the driver and the passengers through audio/video interfaces. To facilitate such a functionality, referring to FIGS. 2 and 3, the infotainment system 130 includes a user interface 132 having a display screen 134 to display one or more information related to one or more functional parameters of the vehicle 102 as well as video content. Moreover, the user interface 132 is configured to enable the user of the vehicle 102 to interact with the infotainment system 130 and receive an input from the user. For so doing, in some embodiments, the user interface 132 may include a keypad. Alternatively, the display screen 134 is a touch enabled screen 136 and may include virtual buttons to enable a user to provide one or more inputs to the vehicle 102.

Also, the vehicle 102 includes a sound system 140, shown in FIG. 1 and FIG. 3, arranged in communication with the infotainment system 130 to enable a playing of audio content. Moreover, the vehicle 102 includes an onboard diagnostic (OBD) port 142 adapted to be accessed by the user and facilitates a connection of the dongle 200 with the vehicle 102 i.e., a controller 144 of the vehicle 102 to facilitate data exchange between the headset 300 and the vehicle 102 to enable the user to control/play the game on the headset 300 via the least one input device 115 of the vehicle 102. The controller 142 includes a processor 146 and a memory 148 to respectively process and store the data, for example control instructions to activate and deactivate the game mode of the vehicle 102 and to facilitate an operation/control of the vehicle 102 and its components, i.e., at least one input device 115 in the game mode. The memory 148 also stores control instructions to operate the vehicle 102 and components of the vehicle 102 in a normal mode upon deactivation of the game mode.

The memory 148 may be integrated into the controller 144, but those skilled in the art will understand that the memory 148 may be separate from the controller 144 but onboard the vehicle 102, and/or remote from the controller 144 and the vehicle 102, while still being associated with and accessible by the controller 144 to store information in and retrieve information from the memory 148 as necessary during the operation of the vehicle 102. Although the processor 146 is contemplated, it is also possible and contemplated to use other electronic components such as a microcontroller, an application specific integrated circuit (ASIC) chip, or any other integrated circuit device. The processor 146 is configured to execute specified instructions, which controls and monitors various functions associated with the vehicle 102, the activation of the game mode when the dongle 200 is connected to the OBD port 142, and the deactivation of the game mode. The controller 144 in communication with the dongle 200 facilitates a transfer of one or more vehicle information, for example, operating parameters of one or more systems of the vehicle 102 with the headset 300 for displaying on a display 302 of the headset 300 when the game mode is active.

As shown in FIG. 1, the dongle 200 includes an OBD port interface 202 to enable the dongle 200 to connect with the OBD port 142, a transceiver 204 to facilitate a communication and data exchange with the headset 300, and a charging port 206 to facilitate a charging of the headset 300 via a suitable charging cable. In an embodiment, the transceiver 204 may be a short range transceiver to enable short range communication with the dongle and the headset. In some embodiments, the transceiver 204 may be a BLUETOOTH, a near field communication device, an ultrawide band sensor, or any other suitable communication device, known in the art, that enables communication and data transfer at short distances. Moreover, the dongle 200 includes a controller 210 that enables the connection of the headset 300 with the vehicle 102 and facilitates the user to play the games on the headset 300 using the input devices 115 of the vehicle 102. Moreover, the controller 210 is configured to receive one or more vehicle parameters from the controller 144 of the vehicle 102 and shares the information with the headset 300 to be suitably displayed on the display 302 that may be a virtual display/screen of the headset 300 while playing game.

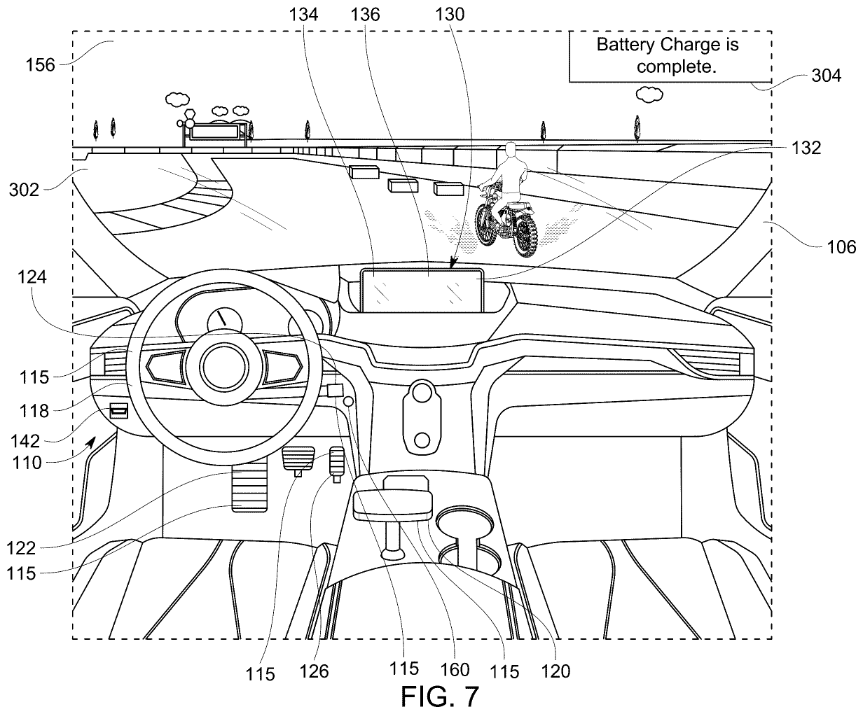

Furthermore, the controller 210 is configured to access/determine an information related to a vehicle model of the vehicle 102 and transfers the information to the headset 300 to adjust the virtual display of the headset 300 according to a shape and size of a windshield 156 of the vehicle 102, as shown in FIG. 7, to provide an immersive experience to the user. The controller 210 may access/determine/receive information related to the vehicle model from the controller 144 of the vehicle 102. Further, the controller 210 may be configured to receive haptic feedback events inside the game and may provide such feedback to the controller 144 of the vehicle 102 to control one or more components of the vehicle 102, for example, seats 114, steering wheel 118, indicator lights, etc., to provide haptic feedback to the user to provide an immersive experience to the user while playing game.

As shown in FIG. 3, the controller 210 includes a processor 212 and a memory 214 to respectively process and store the data to enable connection of the dongle 200 with vehicle 102 and the headset 300 and transfer of control instructions and one or more vehicle parameters from the vehicle 102 to the headset 300 upon activation of the game mode of the vehicle 102. The memory 214 may be integrated into the controller 210, but those skilled in the art will understand that the memory 214 may be separate from the controller 210 but onboard the dongle 200, and/or remote from the controller 210 and the dongle 200, while still being associated with and accessible by the controller 210 to store information in and retrieve information from the memory 214 as necessary during the operation of the dongle 200. Although the processor 212 is contemplated, it is also possible and contemplated to use other electronic components such as a microcontroller, an application specific integrated circuit (ASIC) chip, or any other integrated circuit device.

The controller 210 i.e., the processor 212 is configured to receive control instructions from the controller 144 corresponding to the actuation of the at least one input device 115, and controls the game played on the headset 300 based on such inputs. For example, the controller 210 is configured to enable a turning of a person or vehicle in a left or a right direction based on the operation or direction of rotation of the steering wheel 118. Also, the controller 210 is configured to increases the speed of a vehicle or person in the game when the accelerator pedal 126 of the vehicle 102 is pressed by the user. Moreover, the controller 210 is configured to apply brakes of the vehicle in the game or slow a speed of movement of the person inside the game upon actuation of the brake lever/pedal 122 of the vehicle 102. Similarly, the controller 210 is configured to actuate the indicators lights or the front and rear light of the vehicle that is being operated inside the game based on the actuation of the indicator lever 120 or light switches. In this manner, the controller 210 is configured to facilitate the playing of the game on the headset 300 with the help of at least one input device 115 of the vehicle 102. Also, the controller 210 is configured to interact and pair with the sound system 140 of the vehicle 102 to play audio/sound being generated or played inside game to provide an immersive experience to the user playing the game.

It may be noted that the controller 144 of the vehicle 102 disables one or more functionalities of the systems of the vehicle 102 associated with one or more input devices of the at least one input device 115 of the vehicle 102 in response to the activation of the game mode of the vehicle 102. It may be noted that, upon the enablement of the game mode, the controller 210 of the dongle 200 in communication with the controller 144 of the vehicle and the headset 300 assigns one or more input devices of the at least one input device 115 with a function of the game to be played on headset 300, and disables functionalities of the systems of the vehicle 102 associated with such one or more input devices. For example, the controller 144 disables the control/turning of wheels of the vehicle 102 in response to the rotation of the steering wheel 118 of the vehicle 102 when the game mode is enabled/active. Accordingly, the wheels of the vehicle 102 do not turn left or right upon turning of the steering wheel 118 in the game mode of the vehicle 102. Similarly, the actuation of the brakes of the vehicle 102 upon pressing of the brake lever 122, the actuation of the indicator lights of the vehicle 102 upon actuation of the indicator lever 124, the acceleration and deceleration of the vehicle 102 based on a position of the accelerator pedal 126, etc. is disabled when the vehicle 102 is in the game mode. Further, in some embodiments, the controller 144 is configured to automatically apply parking brake 158 of the vehicle 102 upon entering the game mode and disables the ignition/starting of the vehicle 102.

Moreover, the controller 144 is configured to disables the game mode when an ignition switch 160 or a starting switch 160 is operated by the user. In some embodiments, the controller 144, via the user interface 132 of the infotainment system 130, displays a notification or message to the user to confirm whether the user wishes to exit the game mode, and exit the game mode and enables the ignition of the vehicle 102 upon such a confirmation from the user. It may be noted that the controller 144 displays the message or the notification upon receiving a request to start the vehicle 102. In some embodiments, the controller 144 may determine a receipt of request to start the vehicle 102 in response to a pressing of the ignition switch 160 of the vehicle 102. Also, the controller 144 is configured to release the parking brake 158 along with the starting of the vehicle 102 upon exit of the game mode and pressing of the ignition switch 160. Also, the controller 210 may prompt the user to disconnect the dongle 200 from the port 142 upon receipt of the request for starting of the vehicle 102, and enables the starting of the vehicle in response to the disconnection of the dongle 200 from the port 142. Moreover, in some embodiments, the user may disconnect the dongle 200 from the port 142 without pressing the ignition switch 160, and in such case, the controller 144 may enable the ignition of the vehicle upon such disconnection and exit the vehicle 102 from the game mode. Upon exit of the vehicle 102 from the game mode, the controller 144 enables/assigns the controls of the various systems or functionalities of the vehicle 102 back to the one or more associated input devices 115 and control such functionalities and systems based on the actuation or control the associated input devices 115 by the user.

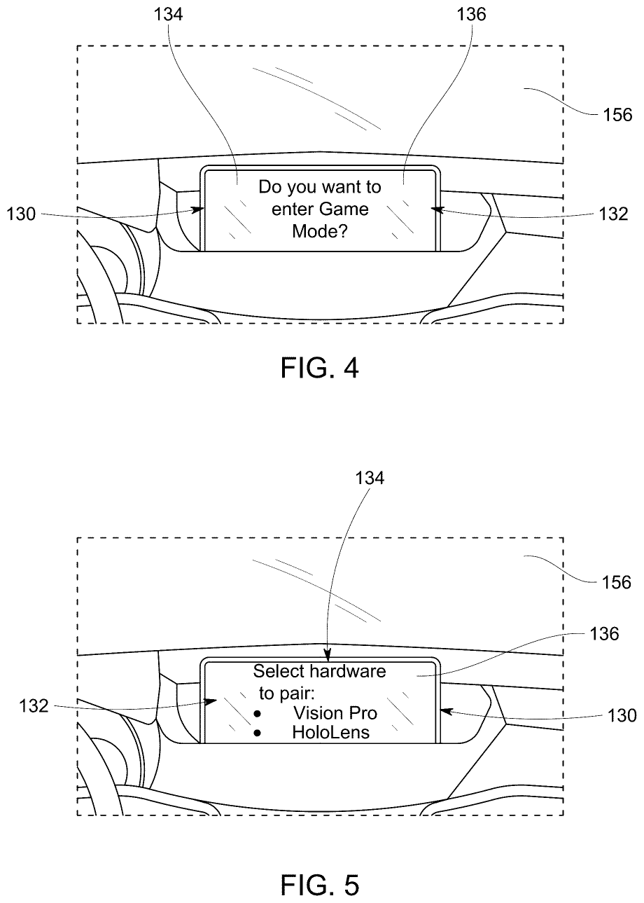

A method for controlling the vehicle 102 via the dongle 200 to active the game mode of the vehicle to enable a user to play game on the headset 300 via the at least one input device 115 of the vehicle 102 is now described. For enabling the game mode of the vehicle 102, the user engages the dongle 200 with OBD port 142 of the vehicle 102. The controller, upon determination of the engagement of the dongle 200 with the OBD port 142, may display, via the display screen 134 of the infotainment system 130, a message/notification to confirm from the user if the user wants to enables the game mode of the vehicle 102, and prompts the user to provide a suitable input via the user interface 132, as shown in FIG. 4. Upon an affirmative confirmation from the user, via the user interface 132, that the user intends to enable the game mode of the vehicle 102 to play a game on the headset 300, the controller 144, via the dongle 200 or otherwise, detects various external devices including the headset 300 arranged in the vicinity, and displays, via the user interface 132, a list of detected external devices, and prompts the user to select the headset 300 for pairing the headset 300 with the dongle 200 and the controller 144 of the vehicle 102, as shown in FIG. 5. The controller 144 is configured to pair the headset 300 with the controller 144 by utilizing the dongle 200 upon receipt of the selection from the user, and activates the game mode of the vehicle 102. Further, the controller 144 disables the ignition of the vehicle 102 and applies the parking brake 158 of the vehicle 102 upon activation of the game mode of the vehicle 102.

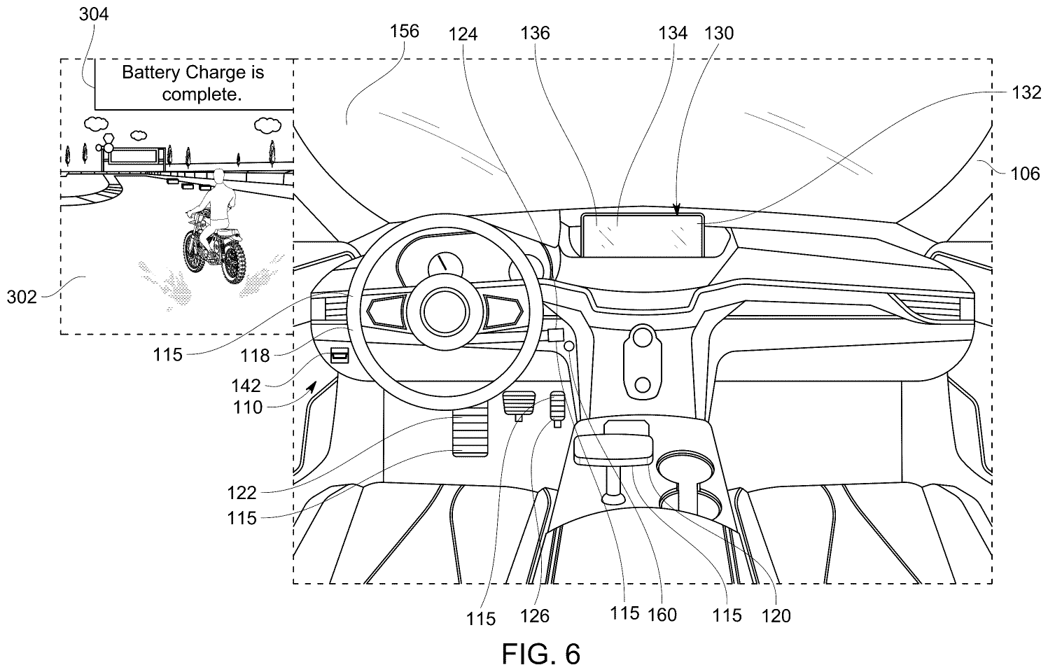

Upon enabling the game mode of the vehicle 102 and pairing with the headset 300 with the dongle 200 and the vehicle 102, the user may start the game on the headset 300. Depending on the game selected by user on the headset 300, the controller 210 of the dongle 200 in association with the controller 144 of the vehicle 102 assigns/associates one or more of the at least one input device 115 of the vehicle 102 with one or more control function of the selected game. For example, for a vehicle based game shown in the FIGS. 6 and 7, the controller 210 in association with the controller 210 assigns/associates the steering vehicle 118 with the left of right turning of the game vehicle, the acceleration pedal 136 for controlling acceleration of the game vehicle, and brake pedal 122 to apply brakes of the game vehicle.

Moreover, the controller 144 of the vehicle 102 disables the control of the functionality of the components of the vehicle 102 associated with the one or more assigned input devices 115 via the one or more assigned input devices 115 till the game mode is active. For example, the controller 144 disables turning of the wheels, the acceleration of the vehicle 102, and braking of the vehicle 102 in response to the maneuvering of the steering wheel 118, the acceleration pedal 126, and the brake pedal 122, respectively when the game mode is active. Rather, the control instructions generated by the controller 144 in response to the actuation of the associated input devices 115 are shared with the controller 210 of the dongle 200 and hence to the headset 300 to suitably control the game being played on the headset 300. In this manner, the user plays the game and controls the game by operating the associated input devices 115 of the vehicle 102. As the user plays game and can see the game on the virtual screen 302 of the headset 300, the controller 210 of the dongle 200 receive the information about one or more vehicle parameters of the vehicle 102, for example, a charging status of the battery 160 of the vehicle 102 from the controller 144 of the vehicle 102, and shares such information with the headset 300. In the illustrated embodiment, the information i.e., notification 304, related to the vehicle parameters, may be displayed on the virtual screen 302 of the headset 300 while playing the game, as shown in FIGS. 6 and 7. In some embodiments, the controller 210 may collect information related to vehicle model, and the controller 210 may control a shape and size of the game screen based on the vehicle model so that the game screen to corresponds to the size and shape of the windshield 156 of the vehicle 102, as shown in FIG. 7. In this manner, the user may get a feel that user is sitting inside the game and hence vehicle system 110 provides an immersive experience to the user.

Moreover, the headset 300 may transfer various sounds generated during playing of the game to the sound system 140 of vehicle 102 via the controller 210 of the dongle 200, and the controller 144 plays the game audio via the sound system 140 of the vehicle 102. Moreover, in some embodiments, the controller 210 in association with the controller 144 may provide the haptic feedback of the game via actuating one or more components of the vehicle 102, for example, vibrating the seats 114, oscillating the steering wheel 118, etc.

Also, in some embodiments, while playing the game, the user may press the ignition switch 160. However, the controller 144 does not allow starting of the vehicle 102 when the game mode is active, and may display a message via the display screen 136 of the infotainment system 132 and/or the virtual screen 302 of the headset 300, informing the user that the ignition is disabled. In some embodiments, the controller 144 may prompt the user via the user interface 132 to provide an input, via the user interface 132, to exit the game mode and exit the game mode upon receipt of such input. In some embodiments, the controller 144 may deactivate the game mode of the vehicle 102 upon disconnection of the dongle 200 from the OBD port 142.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A vehicle, comprising:
at least one input device adapted to be operated by a user to control at least one driving function of the vehicle;
an onboard diagnostic port adapted to be engaged with a dongle; and
a controller communicatively coupled to the onboard diagnostic port, the dongle and the at least one input device, the controller is configured to:
detect an engagement of the dongle with the onboard diagnostic port;
activate a game mode of the vehicle upon detection of the engagement of the dongle with the onboard diagnostic port;
disable an ignition of the vehicle in response to the activation of the game mode; and
associate the at least one input device with at least one control function of a game adapted to be played using a virtual reality headset,
wherein the at least one control function of the game being played on the virtual reality headset is controlled in response to the actuation of the at least one input device.

2. The vehicle of claim 1, wherein the controller is configured to disable the control of the at least one driving function of the vehicle associated with the at least one input device in response to the activation of the game mode.

3. The vehicle of claim 1, wherein the controller is configured to disable the game mode upon disconnection of the dongle from the onboard diagnostic port, and associate the control of the at least one driving function with the at least one input device.

4. The vehicle of claim 1, wherein the controller is configured to share an information related to one or more vehicle parameters with the dongle to display the one or more vehicle parameters on a virtual screen of the headset when the game mode is active.

5. The vehicle of claim 1 further comprising an infotainment system having a user interface to enable an interaction of the vehicle with the user, and the controller is communicatively coupled to the user interface and configured to prompt the user, via the user interface, to select the game mode upon engagement of the dongle with the onboard diagnostic port and activate the game mode in response to the selection.

6. The vehicle of claim 1, wherein the at least one input device includes one or more of a steering wheel, an accelerator pedal, and a brake pedal.

7. The vehicle of claim 1 further comprising a sound system communicatively coupled to the controller, wherein the controller is configured to receive and play audio of the game being played on the virtual reality headset.

8. The vehicle of claim 1, wherein controller is configured to actuate a parking brake of the vehicle in response to the activation of the game mode.

9. A vehicle system, comprising:
a dongle; and
a vehicle including
at least one input device adapted to be operated by a user to control at least one driving function of the vehicle;
an onboard diagnostic port, wherein the dongle is adapted to be removably coupled to the onboard diagnostic port and configured to facilitate a sharing of control instructions from the vehicle to a virtual reality headset to enable a user to control a game on the virtual reality headset; and
a controller communicatively coupled to the onboard diagnostic port, the dongle and the at least one input device, the controller is configured to:
detect an engagement of the dongle with the onboard diagnostic port;
activate a game mode of the vehicle upon detection of the engagement of the dongle with the onboard diagnostic port;
disable an ignition of the vehicle in response to the activation of the game mode; and
associate the at least one input device with at least one control function of a game adapted to be played using the virtual reality headset,
wherein the at least one control function of the game being played on the virtual reality headset is controlled in response to the actuation of the at least one input device.

10. The vehicle system of claim 9, wherein the controller is configured to disable the control of the at least one driving function of the vehicle associated with the at least one input device in response to the activation of the game mode.

11. The vehicle system of claim 9, wherein the controller is configured to disable the game mode upon disconnection of the dongle from the onboard diagnostic port, and associate the control of the at least one driving function with the at least one input device.

12. The vehicle system of claim 9, wherein the controller is configured to share an information related to one or more vehicle parameters with the dongle to display the one or more vehicle parameters on a virtual screen of the headset when the game mode is active.

13. The vehicle system of claim 9 further comprising an infotainment system having a user interface to enable an interaction of the vehicle with the user, and the controller is communicatively coupled to the user interface and configured to prompt the user, via the user interface, to select the game mode upon engagement of the dongle with the onboard diagnostic port and activate the game mode in response to the selection.

14. The vehicle system of claim 9, wherein the at least one input device includes one or more of a steering wheel, an accelerator pedal, and a brake pedal.

15. The vehicle system of claim 9 further comprising a sound system communicatively coupled to the controller, wherein the controller is configured to receive and play audio of the game being played on the virtual reality headset.

16. The vehicle system of claim 9, wherein the controller is configured to actuate a parking brake of the vehicle in response to the activation of the game mode.

17. A dongle adapted to be connected to an onboard diagnostic port of a vehicle, the vehicle includes at least one input device to control at least one driving function of the vehicle, the dongle comprising:
a controller configured to
facilitate an activation of a game mode of the vehicle;
connect the vehicle to a virtual reality headset to enable a user to play a game;
receive at least one control instruction generated in response to an actuation of the at least one input device upon activation of the game mode of the vehicle; and
share the at least one control instruction with the virtual reality headset to enable a user to control of at least one control function of the game being played on a virtual reality headset via the at least one input device.

18. The dongle of claim 17 further comprising a transceiver communicatively coupled to the controller to facilitate the connection of the vehicle to the virtual reality headset and to enable a data exchange between the dongle and the virtual reality headset.

19. The dongle of claim 18, wherein the transceiver is a short range transceiver that facilitates a short range communication between the virtual reality headset and the dongle.

20. The dongle of claim 17, wherein the controller is configured to receive an information related to one or more vehicle parameters from the vehicle and share the information with the virtual headset to display on a virtual screen of the virtual reality headset.
